(19) United States
(12) Patent Application Publication
(10) Pub. No.: US 2014/0168015 A1
(43) Pub. Date: Jun. 19, 2014

(54) MOBILE COMMUNICATION TERMINAL

(71) Applicant: Pantech Co., Ltd., Seoul (KR)

(72) Inventor: Gi Dae KIM, Seoul (KR)

(73) Assignee: Pantech Co., Ltd., Seoul (KR)

(21) Appl. No.: 14/026,504

(22) Filed: Sep. 13, 2013

(30) Foreign Application Priority Data
Dec. 18, 2012 (KR) 10-2012-0148629

(51) Int. Cl. H01Q 5/00; H01Q 1/24

(52) U.S. Cl. CPC H01Q 5/001; H01Q 1/243
USPC 343/702; 343/700 MS

(57) ABSTRACT

A mobile communication terminal includes a case to house at least one component of the mobile communication terminal, an antenna having a power supply terminal and a first radiation pattern part, and a terminal insertion slot disposed in a portion of the case, in which a first portion of the first radiation pattern part extends from the power supply terminal towards a first end portion of the case, and a second portion of the first radiation pattern part extends from the first portion of the first radiation pattern part towards a second end portion of the case, and a plane of the second end portion of the case crosses a plane of the first end portion of the case.

### CROSS-REFERENCE TO RELATED APPLICATION

This application claims priority from and the benefit under 35 U.S.C. §119(a) of a Korean Patent Application No. 10-2012-0148629, filed on Dec. 18, 2012, the entire disclosure of which is incorporated herein by reference for all purposes.

### BACKGROUND

1. Field

The following description relates to a terminal capable of communicating while moving, and more particularly, to a mobile communication terminal having an internal antenna.

2. Discussion of the Background

A mobile communication terminal, such as a cellular phone, is widely used as a type of personal communication device capable of performing a voice calling operation and/or a wireless communication operation while moving. In recent years, a smart phone, as an intelligent terminal in which computer supporting operations, such as Internet communication and information search, are added to the cellular phone, has been released and is becoming popular.

In general, a terminal, such as the smart phone, is configured to have a bar type configuration, which allows a user to search the Internet or watch multimedia conveniently through a relatively large screen, which may be disposed on a surface of the body of the bar type terminal. Screen size may be smaller in size than the body surface on which it is disposed thereon. A screen of the terminal is becoming larger in size in accordance with expectations of users preferring a larger screen to search the Internet and watch multimedia. However, as the screen of the terminal increases, the overall size of the terminal also increases, and thereby portability is degraded. Accordingly, to increase portability of the terminal, methods of reducing a case area of the terminal other than the screen are being sought.

Meanwhile, a smaller internal antenna to aid in slimming or downsizing of the overall size of the terminal is generally employed. However, as the case size of the terminal is reduced, a space allotted for the antenna in the case becomes smaller. Accordingly, deploying the antenna in consideration of influences with peripheral components in the case while securing performance of the antenna is a big challenge.

Moreover, due to the development of wireless mobile communication standards, more recent terminals need to support multi-band frequencies. Accordingly, the antenna needs to be configured with, for example, a structure having a plurality of radiation pattern parts therein, for high-frequency and low-frequency bands, and thus deployment design technology of the antenna is more demanding.

### SUMMARY

Exemplary embodiments of the present invention provide a mobile communication terminal having an internal antenna.

Additional features of the invention will be set forth in the description which follows, and in part will be apparent from the description, or may be learned by practice of the invention.

Exemplary embodiments of the present invention provide a mobile communication terminal including a case to house at least one component of the mobile communication terminal; an antenna having a power supply terminal and a first radiation pattern part; and a terminal insertion slot disposed in a portion of the case, in which a first portion of the first radiation pattern part extends from the power supply terminal towards a first end portion of the case, and a second portion of the first radiation pattern part extends from the first portion of the first radiation pattern part towards a second end portion of the case, and in which a plane of the second end portion of the case crosses a plane of the first end portion of the case.

Exemplary embodiments of the present invention provide a multiband antenna including a power supply terminal; a first radiation pattern including a first portion extending in a first direction from the power supply terminal, a second portion extending in a second direction from the first portion of the first radiation pattern, the second direction crossing the first direction, a third portion extending in a third direction from the first portion of the first radiation pattern, the third direction crossing the first direction such that the third portion is disposed across from the second portion, and a fourth portion extending in a fourth direction from the third portion of the first radiation pattern, the fourth direction crossing the second direction such that the fourth portion is disposed across from the first portion; and a second radiation pattern part including a first portion extending in the first direction from the power supply terminal, and a second portion extending in the third direction from the first portion of the second radiation pattern.

Exemplary embodiments of the present invention provide a mobile communication terminal including a case to house at least one component of the mobile communication terminal; a multiband antenna having a power supply terminal; a first radiation pattern part including a first portion extending from the power supply terminal towards a first end portion of the case, and a second portion extending from the first portion of the first radiation pattern part towards a second end portion of the case, in which a plane of the second end portion of the case crosses a plane of the first end portion of the case; and a second radiation pattern part including a first portion extending from the power supply terminal towards the first end portion of the case, and a second portion extending from the first portion of the second radiation pattern part towards a third end portion of the case, in which a plane of the third end portion of the case crosses a plane of the first end portion of the case such that the third end portion of the case is disposed across from the second end portion of the case; and a terminal insertion slot disposed along the first end portion of the case, in which the second portion of the first radiation pattern part extends from the first portion of the first radiation pattern part beyond an area in which the terminal insertion slot is disposed in the first end portion of the case.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a front view illustrating a mobile communication terminal according to an exemplary embodiment of the present invention.

FIG. 2 is an exploded perspective view of a mobile communication terminal according to an exemplary embodiment of the present invention.

FIG. 3 is a perspective view illustrating a mobile communication terminal viewed from a lower end of rear side according to an exemplary embodiment of the present invention.

FIG. 4 is a schematic cross-sectional view taken along the line A-A of FIG. 1 according to an exemplary embodiment of the present invention.

FIG. 5 is a perspective view illustrating an antenna of a mobile communication terminal according to an exemplary embodiment of the present invention.

FIG. 6 is a perspective view illustrating an antenna of a mobile communication terminal formed in an antenna support according to an exemplary embodiment of the present invention.

FIG. 7 is a perspective view illustrating a form in which an antenna support is integrated in a rear case of a mobile communication terminal according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

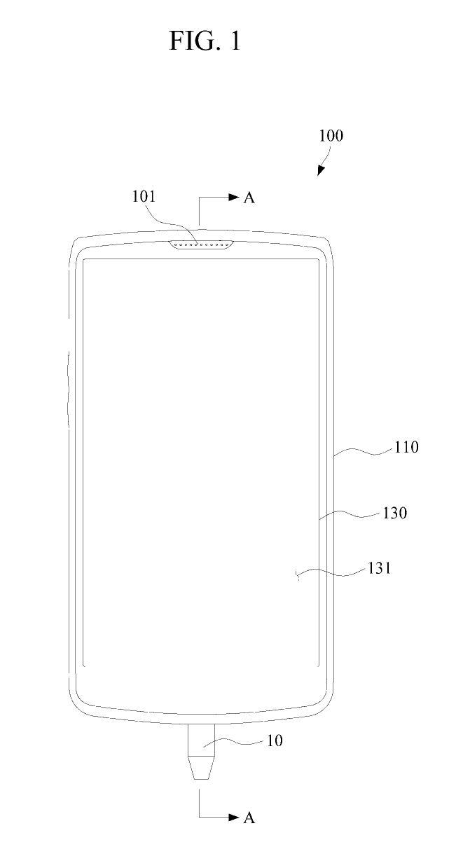

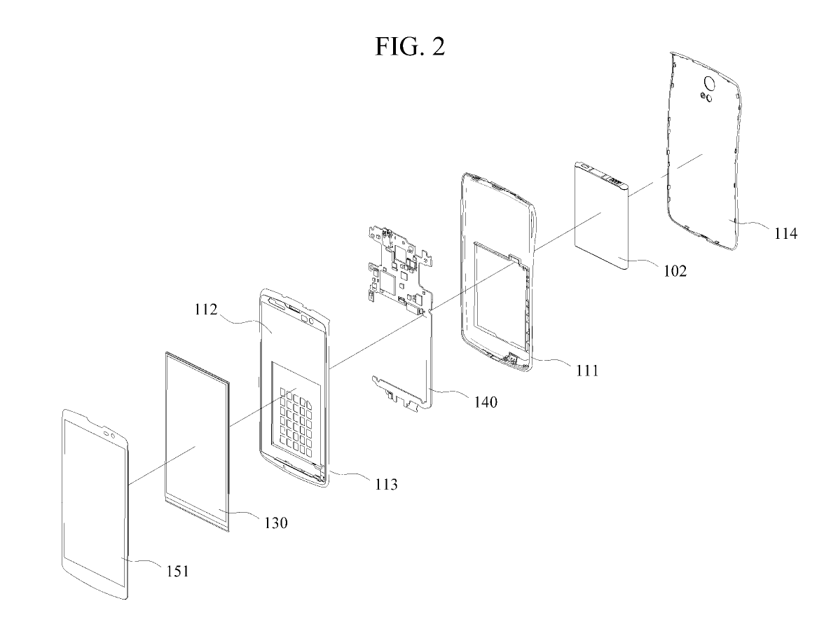

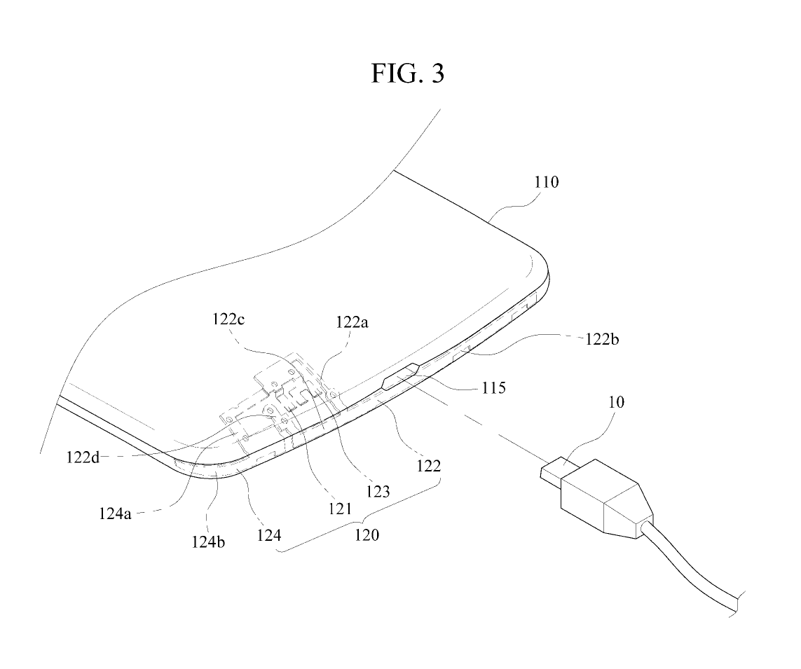

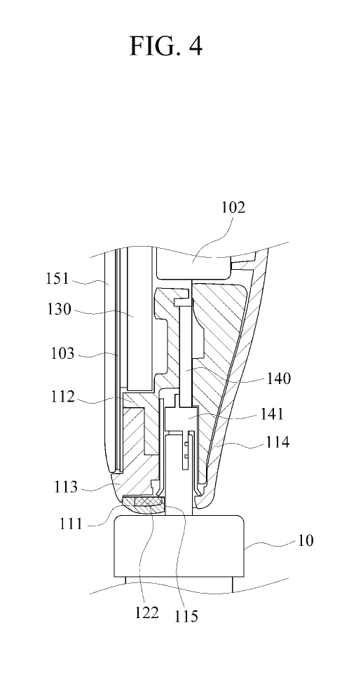

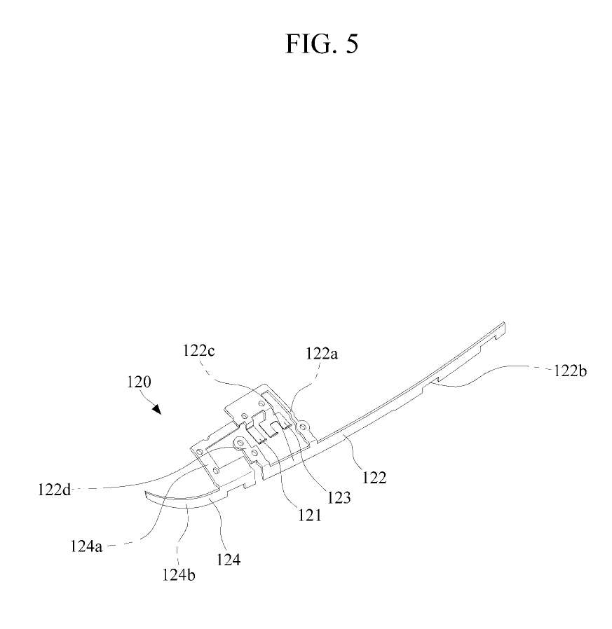

FIG. 1 is a front view illustrating a mobile communication terminal according to an exemplary embodiment of the present invention. FIG. 2 is an exploded perspective view of a mobile communication terminal according to an exemplary embodiment of the present invention. FIG. 3 is a perspective view illustrating a mobile communication terminal viewed from a lower end of a rear side according to an exemplary embodiment of the present invention. FIG. 4 is a schematic cross-sectional view taken along the line A-A of FIG. 1 according to an exemplary embodiment of the present invention. FIG. 5 is a perspective view illustrating an antenna of a mobile communication terminal according to an exemplary embodiment of the present invention.

As illustrated in FIG. 1, FIG. 2, FIG. 3, FIG. 4 and FIG. 5, a mobile communication terminal 100 includes a case 110 and an antenna 120. The case 100 may accommodate and protect various components included therein, such as a display module 130 and a circuit board 140. Further, although not illustrated in the figures, a mobile communication terminal may include other various hardware components, such as one or more processors, a memory, a camera, and the like. Also, although described herein as a mobile communication terminal, aspects need not be limited thereto such that the mobile communication terminal may be a cellular telephone, a smartphone, a tablet computer, a laptop computer, a desktop computer, and the like.

The case 110 is configured to expose a screen 131 of the display module 130 through a front panel. Since a user may use the mobile communication terminal 100 while viewing the screen 131 from the front of the screen 131, the front panel of the case 110 may refer to a part facing the same direction as the screen 131. More specifically, the front panel of the case 110 may be disposed on a first or top surface of the mobile communication terminal 100.

A rear panel of the case 110 may refer to a part positioned on a surface opposite of the front panel of the case 110. More specifically, the rear panel of the case 110 may be disposed on a second or bottom surface of the mobile communication terminal 100. A receiver 101 to deliver a speaker's voice to a user of the mobile communication terminal 100 may be disposed on an upper portion of the case 110. An upper end portion of the case 110 may be referred to as an edge area within a reference distance to the receiver 101 and a lower end portion of the case 110 may be referred to as an edge area positioned opposite of the upper end portion of the case 110. Further, the upper end portion of the case 110 and/or the lower end portion of the case 110 may be shorter in length than a side portion of the case 110. According to aspects of the invention, the mobile communication terminal 100 extends in a direction parallel to the side portions of the case 110. Further, the upper end portion and the lower end portion may extend in a direction normal or perpendicular to a direction in which the mobile communication terminal 100 extends.

Referring to FIG. 2, the case 110 may include a rear case 111 and a front case 112. The rear case 111 may be configured to have an opening. More specifically, the rear panel of the rear case 111 includes a through-hole to accommodate a battery 102. The battery 102 may be detachable. The front case 112 is disposed in front of the rear case 111 when a user faces the screen 131 of the mobile communication terminal 100. The front case 112 may be configured, such that a central region of the front panel is opened. The display module 130 may be accommodated or disposed in the front case 112 through a front panel opening of the front case 112 while the screen 131 faces the front side. Front side may refer to a side the user may view the screen 131 of the mobile communication terminal 100.

The screen 131 may be protected by a glass plate 151 disposed to cover the screen 131 in the front of the front case 112. A bezel 113 may be provided around the circumference of the front case 112. The bezel 113 may fix an edge portion of the glass plate 151 to the front case 112 and may fix the front case 112 to the rear case 111. A battery case 114 may be detachably attached in the rear panel of the rear case 111.

The display module 130 may be configured with, for example, a liquid crystal display (LCD) module or an organic light emitting diode (OLED) module. A touch window 103 may be attached on the screen 131 of the display module 130. The touch window 103 may be attached by lamination on the glass substrate 151. A button part (not illustrated) for a command input may be provided in a lower area of the screen 131 of the display module 130 or a lower area of the screen 131.

A circuit board 140 may be accommodated between the rear case 111 and the front case 112. Further, the circuit board 140 may be disposed in the rear side of the display module 130. The circuit board 140 may include a controller to control the overall mobile communication terminal 100. The controller may include an antenna signal processing unit to process a signal transmitted or received through the antenna 120.

A power supply unit may be provided in the circuit board 140 to apply an electrical signal to the antenna 120. A ground may be provided in the circuit board 140 to ground the antenna 120. In addition, a terminal connector 141 may be provided in the circuit board 140 to connect with an external connection terminal 10.

A terminal insertion slot 115 into which the external connection terminal 10 is inserted is configured in the lower end portion of the case 110. For example, the terminal insertion slot 115 may be configured to penetrate the central portion of the lower end portion of the rear case 111 or case 110. However, aspects of the invention may not be limited thereto, such that the insertion slot 115 may be configured at different locations along the case of the mobile communication terminal 100. The central portion of the lower end portion of the case 110 may refer to a position at which a distance between the terminal insertion slot 115 and a left side position of the case 110, and a distance between the terminal insertion slot 115 and a right side position of the case 110 are approximately similar or the same. In an example, a left side and a right side of the lower end portion of the case 110 may be symmetrically configured with respect to the terminal insertion slot 115. The terminal insertion slot 115 may allow the external connection terminal 10 to be inserted therein to connect to the terminal connector 141 of the circuit board 140. The external connection terminal 10 may be, for example, a USB terminal for charging or data communication.

The antenna 120 may be disposed in the lower area or portion of the case 110. However, aspects of the invention are not limited thereto, such that the antenna 120 may be disposed in the upper area, a side area, or a central area of the case 110. The lower area of the case 110 may refer to an area that is positioned to be lower than the battery 102. More specifically, the antenna 120 may be disposed along or towards an edge portion of the lower area of the case 110. The antenna 120 includes a power supply terminal 121 and a first radiation pattern part 122. The power supply terminal 121 may be connected to the power supply unit of the circuit board 140, which may apply electrical signals. The power supply terminal 121 may be disposed, without limitation, in one side of the case 110 with respect to the terminal insertion slot 115 is disposed. For example, the power supply terminal 121 may be disposed in one side of the end of the case 110 in which the terminal insertion slot 115 is disposed. Referring to FIG. 3, the power supply terminal 121 is shown to be disposed on the left side of the lower area of the case 110. However, aspects of the invention are not limited thereto, such that the power supply terminal 121 may be disposed on the left side of other areas of the case 110 or the right side of the case 110.

The lower area of the case 110 may be divided into a left side and a right side with respect to the terminal insertion slot 115 or a central region of the case 110. A first side of the case 110 may referred to as one of the left or right sides of the lower area of the case 110. A second side of the case 110 may refer to as the other of the left and right sides of the lower area of the case 110.

For example, the power supply terminal 121 may be disposed in a left or right side with respect to the rear panel of the case 110. However, aspects of the invention are not limited thereto, such that the power supply terminal 121 may be disposed at different areas or locations with respect to case 110. A portion of the power supply terminal 121 other than portions connected with the power supply unit of the circuit board 140 may be disposed in, for example, the rear case 111 or case 110, so as not to be exposed. The power supply terminal 121 may be disposed on an inner surface of the rear case 111 or case 110.

When the electrical signal is applied through the power supply terminal 121, a first radiation pattern part 122 connected to the power supply terminal 121 may transmit and/or receive electromagnetic waves by resonating at a first reference frequency band. The first radiation pattern part 122 may extend from a portion of the case 110 in which the terminal insertion slot 115 is disposed toward an edge portion of the case 110. As shown in FIG. 3, the first radiation pattern part 122 may extend from one side of the end of the case 110 in which the terminal insertion slot 115 is disposed towards another side of the same end of the case 110. For example, the first radiation pattern part 122 may extend from one side or portion of the case 110 toward another side or portion of the terminal insertion slot 115 with respect to the terminal insertion slot 115 by crossing through a central region of the case at a lower end portion of the case 110. If the power supply terminal 121 is disposed in a left side or portion of the case 110, the first radiation pattern part 122 may extend from a left side or portion of the case 110 toward a right side or portion of the terminal insertion slot 155 by crossing through a central region of the case at the lower end portion of the case 110.

The first radiation pattern part 122 may be configured to cross through or over at least a reference portion, such as a central, a left, or a right portion, of the lower end portion of the case 110. As shown in FIG. 3, the first radiation pattern part 122 may be configured to be disposed in a gap or an area between the terminal insertion slot 115 and the front panel or a surface panel of the case 110 along a lower end portion of the case 110. More specifically, a first portion 122a of the first radiation pattern part 122 may extend from the power supply terminal 121 toward the lower end portion of the case 110. Further, a second portion 122b of the first radiation pattern part 122 may further extend from the first portion 122a towards a side portion of the case 110, such as a right side portion, as illustrated in FIG. 5 to provide for an L shape figure. More specifically, the second portion 122b of the first radiation pattern part 122 extends along a lower end edge or portion of the case 110 towards the side portion of the case 110 and crosses through or over a central region of the case 110 or the terminal insertion slot 115. Further, the first radiation pattern part 122 may be configured as a strip type and disposed in the case 110 not to be exposed to external elements. The first radiation pattern part 122 may be disposed in an inner surface of the rear case 111 or case 110. The first radiation pattern part 122 may be made of a metal material.

A third portion 122c of the first radiation pattern part 122 may be configured to further extend from the first portion 122a of the first radiation pattern part 122, which may be a portion extending towards the lower end portion of the rear case 111 or case 110, towards an opposite side portion of the case 110, such as a left side portion of the case 110 or an opposite side of the terminal insertion slot 115. A fourth portion 122d of the first radiation pattern part 122 may be configured to extend from the third portion 122c of the first radiation pattern part 122 towards upper end portion of case 110, such that the first radiation pattern part 122 is configured to have an inverted-F shape. The first radiation pattern part 122 may have a variety of shapes, which may include, without limitation, a meander shape, a loop shape, a wire shape, and other shapes that resonate at a reference frequency band. A ground terminal part 123, which may be configured to ground the first radiation pattern part 122 in the circuit board 140, may be disposed in the antenna 120.

Further, since the first radiation pattern part 122 of the antenna 120 has a shape that extends from one side or portion of the terminal toward another side of the terminal by crossing through or over a central region of the terminal or the vicinity of the terminal insertion slot 115, it may be possible to deploy the antenna 120 while securing performance of the antenna 120.

More specifically, due to a configuration of the mobile communication terminal 100 with a larger screen while maintaining portability, in a structure having a limited space for deploying the antenna 120 in the case 110, even when the terminal insertion slot 115 is disposed in the central portion of the lower end portion of the case 110, the first radiation pattern part 122 may extend to cross through or over the terminal insertion slot 115, such that both sides portions divided by the terminal insertion slot 115 area or a central region may be utilized. Accordingly, a degree of freedom of the antenna 120 design may be increased. For example, if the first radiation pattern part 122 is to support a high frequency band, since the first radiation pattern part 122 has a shape that extends across lower end portion of the case 110, it may be possible to design an antenna or a radiation pattern part with a length sufficient to support the high frequency band.

In addition, the first radiation pattern part 122 may be disposed to be separated above a reference distance or proximity from electronic components in the circuit board 140, which may influence transmission and reception of the antenna 120. Compared to an operating environment in which the external connection terminal 10 may not be used in the mobile communication terminal 100, a property value of the antenna 120 may deviate from a normal value in an environment in which the external connection terminal 10 is used. According to aspects of the invention, such deviation may be reduced. Therefore, the first radiation pattern part 122 may implement a pattern, such that deviation may be quantified to be corrected as a property value of the antenna 120 in a general environment. As a result, a pattern design of the antenna 120 capable of maintaining performance of the antenna 120 according to inclusion of the external connection terminal 10 may be possible.

Meanwhile, the antenna 120 may further include a second radiation pattern part 124. As shown in FIG. 3 and FIG. 5, the second radiation pattern part 124 is connected with the power supply terminal 121. The second radiation pattern part 124 may be configured to resonate at a frequency band different from that of the first radiation pattern part 122, which may be disposed at a different side or portion of the terminal from the second radiation pattern part 124. Since the antenna 120 includes the second radiation pattern part 124, the antenna 120 may support multi-band transmission and reception.

The first radiation pattern part 122 may be configured to resonate at a low frequency band, for example, a band of 700 megahertz (MHz) to 960 MHz. The first radiation pattern part 122 capable of resonating at a low frequency band may support, for example, Long Term Evolution (LTE) 700 MHz, Global System for Mobile Communication (GSM) 850 MHz, and GSM 900 MHz. The second radiation pattern part 124 may be configured to resonate at a high frequency band, for example, a band of 1700 MHz to 2100 MHz. The second radiation pattern part 124 capable of resonating at a high frequency band may support, for example, Digital Cellular Mobile Communication Service (DCS) 1.8 gigahertz (GHz), Personal Communication Service (PCS) 1.9 GHz, and Wideband Code Division Multiple Access (WCDMA) 2.1 GHz.

According to aspects of the invention, lengths of the first radiation pattern part 122 and the second radiation pattern part 124 may be inversely proportional to a size of signal frequency and may be proportional to a length of signal wave. For example, the length of the second radiation pattern part 124 supporting high frequency band may be shorter than the length of the first radiation pattern part 122 supporting a lower frequency band.

The second radiation pattern part 124 may have a variety of shapes that support the high frequency band. For example, a first portion 124a of the second radiation pattern part 124 may extend towards the lower end portion of the case 110 from the power supply terminal 121, and a second portion 124b of the second radiation pattern part 124 may extend from the first portion 124a towards a side portion of the case, such as a left side portion, away from the first radiation pattern part 122. More specifically, the second portion 124b of the second radiation part 124 extend along a lower end edge or portion of the case 110 and towards a side edge or portion of the case 110 away from the terminal insertion slot 115 or central region of the case 110. The second radiation pattern part 124 may be configured as a strip type and disposed in the rear case 111 or case 110 not to be exposed. The second radiation pattern part 124 may be configured in an inner surface of the rear case 111 or case 110. The second radiation pattern part 124 may be made of a metal material.

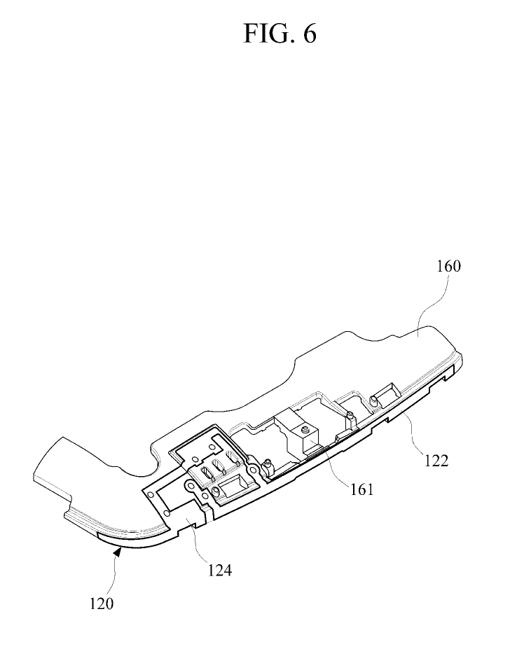

FIG. 6 is a perspective view illustrating an antenna of a mobile communication terminal formed in an antenna support according to an exemplary embodiment of the present invention.

As illustrated in FIG. 6, the antenna 120 may be disposed in an antenna support 160. For example, the antenna 120 may be integrated in the antenna support 160 by insert injection. More specifically, after the antenna 120 is molded, by injection molding the antenna support 160 while the molded antenna 120 is inserted into the injection mold, the antenna 120 may be integrated or encased in the antenna support 160. As another example, after the antenna support 160 is firstly molded, the antenna 120 may be patterned in the molded antenna support 160 with a method of, for example, printing and deposition.

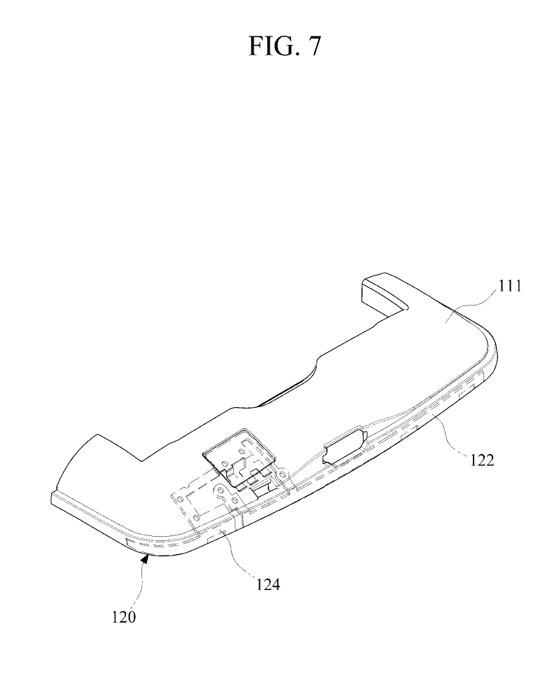

FIG. 7 is a perspective view illustrating a form in which an antenna support is integrated in a rear case of a mobile communication terminal according to an exemplary embodiment of the present invention.

Referring to FIG. 7, an antenna support may be integrated in a case of the mobile communication terminal, for example, in or under the rear case 111 or case 110. Further, the antenna support 160 may be integrated in the rear case 111 or case 110 by injection molding the rear case 111 or case 110 while the antenna support 160 having the antenna 120 disposed thereon is inserted into the injection mold.

If the antenna support 160 is integrated in the rear case 111 or case 110, the first radiation pattern part 122 and the second radiation pattern part 124 of the antenna 120 may be disposed in the rear case 111 or case 110. More specifically, the first radiation pattern part 122 and the second radiation pattern part 124 of the antenna 120 may be disposed in the rear case 111 or case 110 by molding. Therefore, a space for deploying or accommodating the antenna 120 in the case 110 may be reduced so that space utilization of the case 120 may be increased and a slim design of the mobile communication terminal 100 may be maintained.

In the antenna support 160, a reinforcing molding part 161 may be molded in a portion corresponding to the terminal insertion slot 115 to maintain strength while molding. After the antenna support 160 is integrated in the rear case 111 or case 110, the reinforcing molding part 161 may be removed from the antenna support 160 by, for example, mechanical processing. Furthermore, since a plurality of protrusions may be configured on a surface of the antenna support 160, the antenna support 160 may be integrated in the rear case 111 or case 110 after insert injection of the antenna support 160. As another example, the antenna support 160 may also be attached to the rear case 111 or case 110.

According to aspects of the invention, in a structure having a limited space for deploying or accommodating an antenna in a terminal case, even when a terminal insertion slot may be disposed in a central region of a lower end portion of a case of a mobile communication terminal, a radiation pattern part may extend to penetrate the vicinity of a terminal insertion slot such that both sides of the terminal insertion slot area may be connectively utilized.

In addition, since the radiation pattern part of the antenna may be disposed to be separated beyond a reference distance or proximity from electronic components in a circuit board, which may influence transmission and/or reception of the antenna, the pattern may be corrigibly implemented, such that a property value of the antenna deviating from a normal value may be reduced in an environment in which the external connection terminal is used in the terminal. Accordingly, it may be possible to increase a degree of freedom of an antenna design while securing performance of the antenna.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A mobile communication terminal, comprising:
a case to house at least one component of the mobile communication terminal;
an antenna comprising a power supply terminal and a first radiation pattern part; and
a terminal insertion slot disposed in a portion of the case,
wherein a first portion of the first radiation pattern part extends from the power supply terminal towards a first end portion of the case, and a second portion of the first radiation pattern part extends from the first portion of the first radiation pattern part towards a second end portion of the case, and
wherein a plane of the second end portion of the case crosses a plane of the first end portion of the case.

2. The mobile communication terminal of claim 1, wherein a third portion of the first radiation pattern part extends from the first portion of the first radiation pattern part towards a third end portion of the case, and
wherein a plane of the third end portion of the case crosses a plane of the first end portion of the case such that the third end portion of the case is disposed across from the second end portion of the case.

3. The mobile communication terminal of claim 2, wherein a fourth portion of the first radiation pattern part extends from the third portion of the first radiation pattern part towards a fourth end portion of the case, and
wherein a plane of the fourth end portion of the case crosses a plane of the second end portion of the case such that the fourth end portion of the case is disposed across from the first end portion of the case.

4. The mobile communication terminal of claim 1, wherein the antenna further comprises a second radiation pattern part,
wherein a first portion of the second radiation pattern part extends from the power supply terminal towards the first end portion of the case, and a second portion of the second radiation pattern part extends from the first portion of the second radiation pattern part towards a third end portion of the case, and
wherein a plane of the third end portion of the case crosses a plane of the first end portion of the case such that the third end portion of the case is disposed across from the second end portion of the case.

5. The mobile communication terminal of claim 1, wherein the second portion of the first radiation pattern part extends through an area in which the terminal insertion slot is disposed.

6. The mobile communication terminal of claim 1, wherein the second portion of the first radiation pattern part extends through a central region of the first end portion of the case.

7. The mobile communication terminal of claim 1, wherein the terminal insertion slot is disposed at a central region of the first end portion of the case.

8. The mobile communication terminal of claim 4, wherein the first radiation pattern part supports a first frequency band and the second radiation pattern part supports a second frequency band different from the first frequency band.

9. The mobile communication terminal of claim 1, wherein the first radiation pattern part is a strip type.

10. The mobile communication terminal of claim 1, further comprising an antenna support to encase the antenna.

11. The mobile communication terminal of claim 10, wherein the antenna support comprises a reinforcing molding part, and
wherein the molding part is molded at a portion of the antenna support corresponding to the terminal insertion slot.

12. The mobile communication terminal of claim 1, wherein the first radiation pattern part is disposed in a gap between terminal insertion slot and a surface panel of the case along the first end portion of the case, and
wherein the surface panel of the case has a larger surface area than the first end portion or the second end portion of the case.

13. A multiband antenna, comprising:
a power supply terminal;
a first radiation pattern, comprising:
a first portion extending in a first direction from the power supply terminal,
a second portion extending in a second direction from the first portion of the first radiation pattern, the second direction crossing the first direction,
a third portion extending in a third direction from the first portion of the first radiation pattern, the third direction crossing the first direction such that the third portion is disposed across from the second portion, and
a fourth portion extending in a fourth direction from the third portion of the first radiation pattern, the fourth direction crossing the second direction such that the fourth portion is disposed across from the first portion; and
a second radiation pattern part, comprising:
a first portion extending in the first direction from the power supply terminal, and
a second portion extending in the third direction from the first portion of the second radiation pattern.

14. The multiband antenna of claim 13, wherein the first radiating pattern part has an inverted F shape.

15. The multiband antenna of claim 13, wherein the multiband antenna is disposed in a case of a mobile communication terminal comprising a terminal insertion slot, and
wherein the second portion of the first radiation pattern part extends through an area of the case in which the terminal insertion slot is disposed.

16. A mobile communication terminal, comprising:
a case to house at least one component of the mobile communication terminal;
a multiband antenna comprising:
a power supply terminal;
a first radiation pattern part, comprising:
a first portion extending from the power supply terminal towards a first end portion of the case, and
a second portion extending from the first portion of the first radiation pattern part towards a second end portion of the case,
wherein a plane of the second end portion of the case crosses a plane of the first end portion of the case; and
a second radiation pattern part, comprising:
a first portion extending from the power supply terminal towards the first end portion of the case, and
a second portion extending from the first portion of the second radiation pattern part towards a third end portion of the case,
wherein a plane of the third end portion of the case crosses the plane of the first end portion of the case such that the third end portion of the case is disposed across from the second end portion of the case; and
a terminal insertion slot disposed along the first end portion of the case,
wherein the second portion of the first radiation pattern part extends from the first portion of the first radiation pattern part beyond an area in which the terminal insertion slot is disposed in the first end portion of the case.

17. The multiband antenna of claim 16, wherein the terminal insertion slot is disposed at a central region of the first end portion of the case.

18. The multiband antenna of claim 16, wherein the first radiation pattern part comprises a third portion, and
wherein the third portion of the first radiation pattern part extends from the first portion of the first radiation pattern part towards the third end portion of the case.

19. The multiband antenna of claim 18, wherein the first radiation pattern part further comprises a fourth portion,
wherein the fourth portion of the first radiation pattern part extends from the third portion of the first radiation pattern part towards a fourth end portion of the case, and
wherein a plane of the fourth end portion of the case crosses the plane of the second end portion of the case such that the fourth end portion is disposed across from the first end portion of the case.

20. The mobile communication terminal of claim 1, wherein the plane of the second end portion of the case is perpendicular to the plane of the first end portion of the case.
